(19) United States
(12) Patent Application Publication
(10) Pub. No.: US 2017/0131803 A1
(43) Pub. Date: May 11, 2017

(54) ACCEPTING PLURAL USER INPUT

(71) Applicant: Intel Corporation, Santa Clara, CA (US)

(72) Inventors: David W. Browning, Beaverton, OR (US); Rajiva K. Sarraju, Portland, OR (US); Marisol Martinez Escobar, Portland, OR (US)

(73) Assignee: Intel Corporation, Santa Clara, CA (US)

(21) Appl. No.: 14/934,444

(22) Filed: Nov. 6, 2015

(51) Int. Cl. G06F 3/041

(52) U.S. Cl. CPC G06F 3/041; G06F 2203/04104

(57) ABSTRACT

Systems, apparatuses, and methods may include a processor configured to accept a first user data stream input from a first region of a configurable touch input display. The processor may be further configured to separately accept concurrent a second user input data stream from a second region of the configurable touch input display. Thus two or more users may concurrently input data to the display. A flexible, foldable display may be employed.

### TECHNICAL FIELD

Embodiments generally relate to accepting plural user input. More particularly, embodiments relate to methods, apparatuses, and systems that may accept input from two or more concurrent users.

### BACKGROUND

Current portable device systems may typically be configured for one user and primarily one task. For example, if a user is watching a video, the video may typically consume the entire screen. If a user is browsing the Internet, the user interface updates to accommodate browsing. Currently, only a single individual may use a portable device for a given task.

### BRIEF DESCRIPTION OF THE DRAWINGS

The various advantages of the embodiments will become apparent to one skilled in the art by reading the following specification and appended claims, and by referencing the following drawings, in which:

FIGS. 1A and 1B are perspective views of an example of a flexible, foldable, touch input display according to an embodiment;

FIG. 2 is a block diagram of an example of a system according to an embodiment; and

FIG. 3 is a flowchart of an example of a method of facilitating input according to an embodiment.

### DETAILED DESCRIPTION

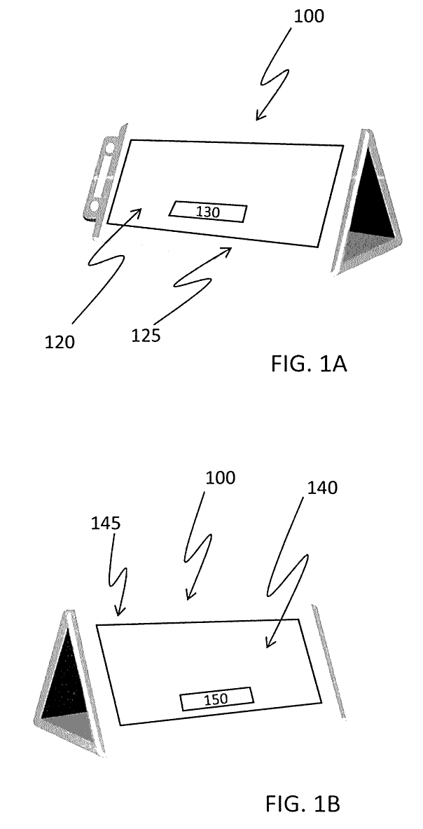

Turning now to FIG. 1A, a touch input display 100 is depicted. As seen in FIGS. 1A and 1B, the display 100 is a configurable device that may be, in one embodiment, a foldable, flexible display configured such that there are two regions, 120 and 140, respectively depicted as being on separate sides of a fold. The display 100 may be, however, a segmented display comprising two or more displays that may optionally be connected by a fastening element such as a hinge or may be independent displays of a single portable device. Any configurable display device that can support viewing by two or more users may be used as the display 100. In the configuration of FIGS. 1A and 1B, the display 100 is both flexible and foldable and has been positioned such that the region 120 may face one user while the region 140 may face another user. These first and second users may optionally be positioned on opposite sides of the folded display 100. In alternative configurations, the display may be extended in a substantially flat horizontal or vertical position and the first and second users may share a substantially similar viewpoint. Each region, however, may be configured for concurrent separate input from each user. For example, ten finger touch input may be accepted by each of the regions 120 and 140. Thus, the overall display 100 may accept “twenty finger” touch input during use. Note that although concurrent input data is accepted, first and second users may input data sequentially, simultaneously, during different time periods, or any other manner of use. The most intensive use may be simultaneous input in both of regions 120 and 140, thus the overall system may accept such usage from two or more users. Further, although not shown, additional regions may be added to the display 100 depending upon a desired number of users of the display.

When the display 100 is selected from foldable, flexible materials, these materials may include any display material that is flexible and foldable and accepts touch input. Exemplary display materials include flexible liquid crystal displays, flexible OLED (organic light-emitting diode/LED) displays, flexible electronic paper, flexible LED displays or any other flexible material capable of being folded that may function as a display. When the display 100 is segmented or separate displays, rigid materials such as rigid liquid crystal displays, rigid LED displays, rigid OLED displays or any other rigid material or flexible material in a rigid housing may be selected. In the embodiments of FIGS. 1A and 1B, the regions 120 and 140 are optionally bounded by adjacent edge regions 125 and 145 that are not configured to accept user input. Thus the first and second users may hold the display 100 in the edge regions 125 and 145 without inadvertently entering data. Further, the illustrated region of folding of the display 100 does not accept user input so that folding does not interfere with data entry.

Optionally, the region 120 may include region 130 that may be a user interface such as a keypad, game controller, or any other user interface device to facilitate user input. Similarly, the region 140 may include a user interface region 150. Depending upon the use determined by the user, user touch input may be limited to the regions 130 or 150 or it may be accepted throughout the regions 120 and 140.

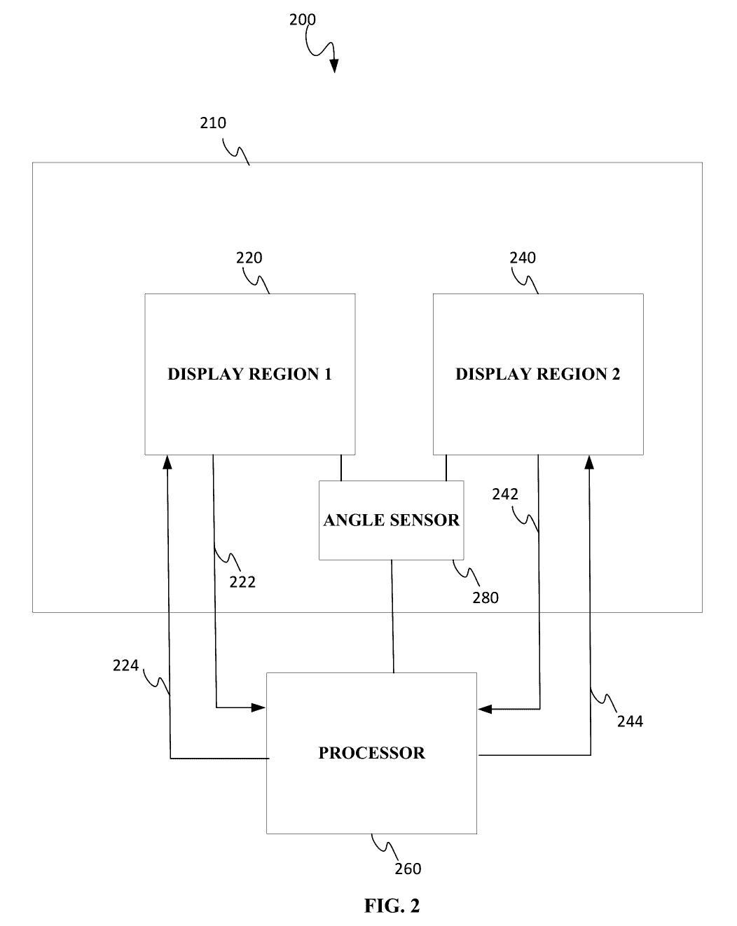

Turning to FIG. 2, a block diagram of a system 200 is depicted. The system 200 includes a display 210 with a region 220 and a region 240. Input from the region 220 may be accepted as a separate data stream along path 222 to a processor 260 while input from the region 240 may be accepted as a separate data stream along path 242 to the processor 260. In this manner, the data from each region may be efficiently processed by the processor 260. Optionally, the processor may be physically co-located within a system or device incorporating the display although it may be positioned outside of the display. Note that the regions 220 and 240 may be partitioned in either hardware (e.g., a dedicated touch region corresponding to the boundaries of a display region) or in software (e.g., a software driver filter separately detecting the regions 220 and 240). Similarly, in order to increase processor efficiency, first user-specific output bound for the region 220 may be output on a separate data stream path 224 to the region 220 while second user-specific output bound for region 240 may be output on a separate data stream path 244 to the region 240. The processor 260 may be configured to receive and process each data stream 222 and 242 independently and may assign independent processing resources associated with the separate data streams. Similarly, the processor 260 may be configured to separately output display data streams along paths 224 and 244 to regions 220 and 240 respectively through independent display output mechanisms.

Typically, a user or application may configure the display 210 to include the regions 220, 240, and any additional regions desired. Alternatively, in a case where the display 210 is to be folded (as described with respect to display 100 of FIGS. 1A and 1B) an angle sensor 280 may be employed to determine an angular orientation of different regions of the display 210 that are created through various folding configurations. The angle sensor may determine the angular orientations of regions relative to a horizontal or vertical plane or it may determine the angular orientations of regions relative to one another. Upon determining the angular orientations of various regions, the angle sensor 280 may communicate its findings to the processor 260. The processor 260 may automatically configure the regions 220 and 240 based on the findings of the angle sensor 280. For example, for the configuration shown in FIGS. 1A and 1B, each region 120 and 140 may be oriented so that users positioned on opposite sides of the display 100 view the regions in, for example a 16:9 aspect ratio (other aspect ratios including 4:3, 16:10, 3:2 may also be used) with the longer edge positioned horizontal to a surface upon which the display rests. At any time, user input may override the angle sensor input to configure display regions.

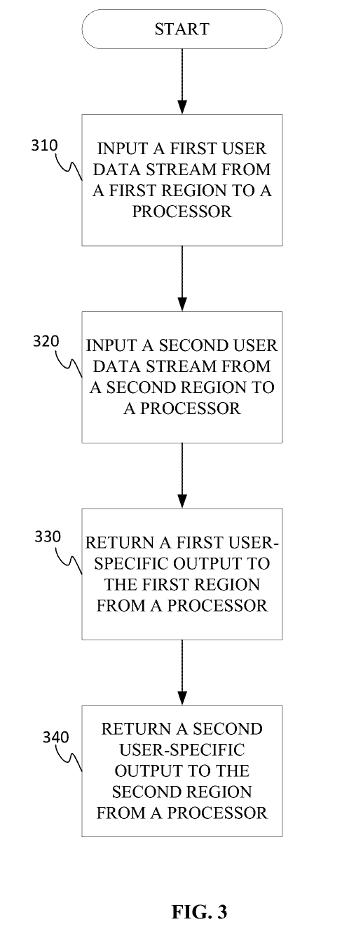

In use, the system 200 of FIG. 2 may perform a method 300 depicted in FIG. 3. With continuing reference to FIGS. 2 and 3, the method 300 may be implemented as one or more modules in a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. At illustrated block 310, the processor 260 may accept input as a first user data stream from a first region such as the region 220 in the system 200. Concurrently, in block 320 the processor 260 may accept input as a second user data stream from a second region such as the region 240 in the system 200. When there is data to be output to the region 220 or the region 240, block 320 returns a first user-specific output to the first region 220 from the processor 260 while in block 330 a second user-specific output is returned to the second region 240 from the processor 260.

Advantageously, using the system of the above embodiments permits two users to accomplish separate, independent tasks on the same portable device using a configurable display(s). Alternatively, the users may interact with each other, such as gaming applications, using the same display and processor. Users may configure a device for convenient viewing and interaction and may set up and customize the display regions independent of one another. Two or more users may separately watch streamed or downloaded content at convenient viewing angles such as facing one another or side-by-side.

### Additional Notes and Examples

Example 1 may include a system configured for concurrent interaction with plural users comprising a configurable touch input display, the configurable display being capable of being configured for viewing by two or more users, at least a first region accepting first user input on the display, at least a second region accepting concurrent second user input on the display, and a processor accepting first user input from the first region as a first data stream and accepting second user input from the second region as a second data stream.

Example 2 may include the system of example 1, wherein the processor returns first user-specific output to the first region and returns second user-specific output to the second region.

Example 3 may include the system of examples 1 or 2, wherein the display is a flexible, foldable display configurable for viewing from a first user viewpoint and from a second user viewpoint at a different viewing angle from the first user viewpoint.

Example 4 may include the system of examples 1 or 2, wherein the first region is configured to accept ten finger touch input and the second region is configured to simultaneously accept ten finger touch input.

Example 5 may include the system of examples 1 or 2, further comprising a first user interface positioned within the first region and a second user interface positioned within the second region.

Example 6 may include the system of examples 1 or 2, further comprising an angle sensor to determine an angular orientation of the first region or the second region or an angle between the first region and the second region.

Example 7 may include an apparatus for concurrent interaction with plural users comprising a processor configured to accept first user input from a first region of a configurable touch input display as a first data stream and to separately accept concurrent second user input from a second region of the configurable touch input display as a second data stream.

Example 8 may include the apparatus of example 7, wherein the processor returns first user-specific output to the first region and returns second user-specific output to the second region.

Example 9 may include the apparatus of examples 7 or 8, wherein the processor is configured to accept ten finger touch input from the first region and to concurrently accept ten finger touch input from the second region.

Example 10 may include a method for input by plural users comprising inputting a first user data stream from a first region of a configurable touch input display to a processor; and separately inputting a second user data stream from a second region of the configurable touch input display to the processor.

Example 11 may include the method of example 10, wherein the same processor returns first user-specific output to the first region and returns second user-specific output to the second region.

Example 12 may include the method of examples 10 or 11, further comprising configuring the display for viewing from a first user viewpoint and from a second user viewpoint at a different viewing angle from the first user viewpoint.

Example 13 may include the method of examples 10 or 11, further comprising accepting ten finger touch input from the first region and concurrently accepting ten finger touch input from the second region.

Example 14 may include the method of examples 10 or 11, further comprising positioning a first user interface within the first region and positioning a second user interface within the second region.

Example 15 may include the method of examples 10 or 11, further comprising determining an angular orientation of the first region or the second region or an angle between the first region and the second region.

Example 16 may include a computer readable storage medium comprising a set of instructions, which, if executed by a processor, cause a computer to accept a first user data stream from a first region of a configurable touch input display; and separately accept a second user data stream from a second region of the configurable touch input display.

Example 17 may include the medium of example 16, wherein, if executed, the instructions cause a computer to: return first user-specific output to the first region and return second user-specific output to the second region.

Example 18 may include the medium of examples 16 or 17, wherein, if executed, the instructions cause a computer to: configure the display for viewing from a first user viewpoint and from a second user viewpoint at a different viewing angle from the first user viewpoint.

Example 19 may include the medium of examples 16 or 17, wherein, if executed, the instructions cause a computer to: accept ten finger touch input from the first region and concurrently accept ten finger touch input from the second region.

Example 20 may include the medium of examples 16 or 17, wherein, if executed, the instructions cause a computer to: position a first user interface within the first region and position a second user interface within the second region.

Example 21 may include the medium of examples 16 or 17, wherein, if executed, the instructions cause a computer to: determine an angular orientation of the first region or the second region or an angle between the first region and the second region.

Example 22 may include an apparatus for concurrent interaction with plural users comprising means for inputting a first user data stream from a first region of a foldable, flexible, touch input display to a processor; and means for separately inputting a second user data stream from a second region of the foldable, flexible, touch input display to the processor.

Example 23 may include the apparatus of example 22, wherein the processor returns first user-specific output to the first region and returns second user-specific output to the second region.

Example 24 may include the apparatus of examples 22 or 23, further comprising configuring the display for viewing from a first user viewpoint and from a second user viewpoint at a different viewing angle from the first user viewpoint.

Example 25 may include the apparatus of examples 22 or 23, further comprising accepting ten finger touch input from the first region and concurrently accepting ten finger touch input from the second region.

Example 26 may include the apparatus of examples 22 or 23, further comprising positioning a first user interface within the first region and positioning a second user interface within the second region.

Example 27 may include the apparatus of examples 22 or 23, further comprising determining an angular orientation of the first region or the second region or an angle between the first region and the second region.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system configured for concurrent interaction with plural users comprising:
a configurable touch input display, the configurable display being capable of being configured for viewing by two or more users;
at least a first region accepting first user input on the display;
at least a second region accepting concurrent second user input on the display;
a processor accepting the first user input from the first region as a first data stream and accepting the second user input from the second region as a second data stream.

2. The system of claim 1, wherein the processor is to return first user-specific output to the first region and is to return second user-specific output to the second region.

3. The system of claim 1, wherein the display is a flexible, foldable display, configurable to be viewed from a first user viewpoint and from a second user viewpoint at a different viewing angle from the first user viewpoint.

4. The system of claim 1, wherein the first region is configured to accept ten finger touch input and the second region is configured to simultaneously accept ten finger touch input.

5. The system of claim 1, further comprising a first user interface positioned within the first region and a second user interface positioned within the second region.

6. The system of claim 1, further comprising an angle sensor to determine an angular orientation of the first region or the second region or an angle between the first region and the second region.

7. An apparatus to facilitate concurrent interaction with plural users comprising:
a processor configured to accept first user input from a first region of a configurable touch input display as a first data stream and to separately accept concurrent second user input from a second region of the configurable touch input display as a second data stream.

8. The apparatus of claim 7, wherein the processor is to return first user-specific output to the first region and is to return second user-specific output to the second region.

9. The apparatus of claim 7, wherein the processor is configured to accept ten finger touch input from the first region and to concurrently accept ten finger touch input from the second region.

10. A method of facilitating input by plural users comprising:
inputting a first user data stream from a first region of a configurable touch input display to a processor; and
separately inputting a second user data stream from a second region of the configurable touch input display to the processor.

11. The method of claim 10, wherein the processor returns first user-specific output to the first region and returns second user-specific output to the second region.

12. The method of claim 10, further comprising configuring the display for viewing from a first user viewpoint and from a second user viewpoint at a different viewing angle from the first user viewpoint.

13. The method of claim 10, further comprising accepting ten finger touch input from the first region and concurrently accepting ten finger touch input from the second region.

14. The method of claim 10, further comprising positioning a first user interface within the first region and positioning a second user interface within the second region.

15. The method of claim 10, further comprising determining an angular orientation of the first region or the second region or an angle between the first region and the second region.

16. A computer readable storage medium comprising a set of instructions, which, if executed by a processor, cause a computer to:
accept a first user data stream from a first region of a configurable touch input display; and
separately accept a second user data stream from a second region of the configurable touch input display.

17. The medium of claim 16, wherein, if executed, the instructions cause a computer to return first user-specific output to the first region and return second user-specific output to the second region.

18. The medium of claim 16, wherein, if executed, the instructions cause a computer to configure the display for viewing from a first user viewpoint and from a second user viewpoint at a different viewing angle from the first user viewpoint.

19. The medium of claim 16, wherein, if executed, the instructions cause a computer to accept ten finger touch input from the first region and concurrently accept ten finger touch input from the second region.

20. The medium of claim 16, wherein, if executed, the instructions cause a computer to position a first user interface within the first region and position a second user interface within the second region.

21. The medium of claim 16, wherein, if executed, the instructions cause a computer to determine an angular orientation of the first region or the second region or an angle between the first region and the second region.
